(19) United States
(12) Patent Application Publication
(10) Pub. No.: US 2020/0190334 A1
(43) Pub. Date: Jun. 18, 2020

(54) SPRAYING PARTICLES AND MANUFACTURING METHOD THEREOF

(71) Applicant: Shin-Etsu Chemical Co., Ltd., Tokyo (JP)

(72) Inventor: Kazuhiro Wataya, Echizen-shi (JP)

(73) Assignee: Shin-Etsu Chemical Co., Ltd., Tokyo (JP)

(21) Appl. No.: 16/713,038

(22) Filed: Dec. 13, 2019

(30) Foreign Application Priority Data
Dec. 14, 2018 (JP) 2018-234278
Dec. 3, 2019 (JP) 2019-218687

(51) Int. Cl. C09D 1/00; C01B 33/20

(52) U.S. Cl. CPC C09D 1/00; C01B 33/20; C01P 2004/03; C01P 2006/90; C01P 2006/12; C01P 2006/11

(57) ABSTRACT

Spraying particles including a rare earth silicate wherein the spraying particles are granulated particles and have a composition represented by the average compositional formula: (A₂Si_{y}O_{z})_{1-a-b}(CeSiₚO_{q})ₐ(EuSiₘOₙ)_{b} or the average compositional formula: A₂Si_{y}O_{z} is manufactured from (A) rare earth oxide particles and/or rare earth silicate particles, and silicon oxide particle, (B) a water-soluble rare earth compound and silicon oxide particles, or rare earth silicate particles by granulating and firing.

### CROSS-REFERENCE TO RELATED APPLICATION

This non-provisional application claims priority under 35 U.S.C. § 119(a) on Patent Application No. 2018-234278 filed in Japan on Dec. 14, 2018, the entire contents of which are hereby incorporated by reference.

### TECHNICAL FIELD

This invention relates to spraying particles including a rare earth silicate, particularly, spraying particles including a rare earth silicate having a composition that differs from the stoichiometric composition. The invention also relates to a method for manufacturing the spraying particles.

### BACKGROUND ART

Recently, ceramic matrix composites (CMCs) such as SiC fiber-reinforced SiC composites are focused as materials for a member used as an aircraft member or a nuclear-related member. The materials are superior in heat resistance and mechanical strength rather than metal materials conventionally-used. So, it is expected increase of utilizing them. However, a ceramic matrix composite has a problem, for example, thinning caused by exposing high-temperature steam when the ceramic matrix composite is used for a member of aircraft engine. Metals or ceramics for use in the member are generally coated for preventing or reducing such damage. The coating used for the purpose is called as environmental barrier coating (EBC), and development is progressing.

Various materials are studied as coating materials of the environmental barrier coating for a ceramic matrix composite. A rare earth silicate that is a multiple oxide of a rare earth element and silicon has high potential. A thermal spraying is known as an advantageous method for coating a rare earth silicate to a ceramic matrix composite, and utilized as a comparatively efficient method. In this case, as spraying particles, rare earth silicate particles are generally used, and a rare earth silicate coating is formed on a ceramic matrix composite by a thermal spraying with supplying the rare earth silicate particles into a flame of a spray gun in a thermal spraying apparatus. The rare earth silicate particles are generally manufactured by mixing rare earth oxide particles and silicon oxide particles, and firing them.

Among the rare earth silicates, rare earth mono silicate represented by the formula L₂SiO₅, wherein L is any one of lanthanoids, i.e., 15 elements consisting of lanthanum (La) of atomic number 57 to lutetium (Lu) of atomic number 71, is one of the material having high potential for an environmental barrier ceramics coating to a ceramic matrix composite. Among the lanthanoids, ytterbium (Yb) and lutetium (Lu), so called heavy rare earth elements, are mainly used, and among the rare earth silicates, ytterbium silicate and lutetium silicate are mainly studied for an environmental barrier ceramics coating to a ceramic matrix composite. One of the reasons for which these silicates are used is that these silicates have a small difference of coefficient of thermal expansion to a ceramic matrix composite as a base, and are not readily peeled from the base. Further, ytterbium silicate has high economic efficiency rather than lutetium silicate since an existential ratio of ytterbium in mineral substances is high, thus, ytterbium silicate is majorly studied. Rare earth silicates other than these silicates are also studied in progress.

### CITATION LIST

Patent Document 1: JP-A 2008-308374

### DISCLOSURE OF INVENTION

To spraying particles of rare earth silicate used for an environmental barrier ceramics coating to a ceramic matrix composite, it is required to the particles having a property being hard to break along with good flowability and a high particle density.

An object of the invention is to provide spraying particles having a property being hard to break along with good flowability and a high particle density, as spraying particles containing a rare earth silicate.

Making investigations on spraying particles containing a rare earth silicate to improve a flowability, and a particle density, particularly a bulk density, and further to improve a crushing strength of particle, the inventors have found that as spraying particles containing a rare earth silicate, granulated particles containing a rare earth silicate having a higher ratio of silicon (Si)/rare earth element (R) in an average composition compared with a rare earth mono silicate R₂SiO₅, wherein R represents rare earth element inclusive of Y, that has a stoichiometric composition of a rare earth silicate have improved flowability, an increased particle density, typically a bulk density, and an increased crushing strength.

Moreover, the inventors have found that the granulated particles of the rare earth silicate having a higher ratio of silicon (Si)/rare earth element (R) in an average composition compared with a stoichiometric composition can be preferably manufactured by the steps of:
(A) mixing rare earth oxide particles and/or rare earth silicate particles, and silicon oxide particles, granulating, and firing;
(B) preparing an aqueous solution of a water-soluble rare earth compound, in which silicon oxide particles are dispersed, precipitating rare earth compound particles in the solution, granulating a mixture of the rare earth compound particles and the silicon oxide particles, and firing; or
(C) granulating rare earth silicate particles, and firing.
   According to the method, the particles, as spraying particles containing a rare earth silicate, having the above-mentioned advantageous properties can be efficiently manufactured with high productivity.

In one aspect, the invention provides spraying particles containing a rare earth silicate wherein the spraying particles are granulated particles and have a composition represented by the following average compositional formula (1):

(A₂Si_{y}O_{z})_{1-a-b}(CeSiₚO_{q})ₐ(EuSiₘOₙ)_{b} (1)

wherein A is at least one trivalent rare earth element selected from the group consisting of Y and lanthanides exclusive of Pm, y is a positive number of at least 1.01 and less than 2, z is a positive number satisfying 3+2×y, p is a positive number of at least 1 and less than 2, q is a positive number satisfying 2+2×p, m is a positive number of at least 1 and less than 2, n is a positive number satisfying 1+2×m, a and b, respectively, are 0 or a positive number of up to 0.3, and a+b is up to 0.3, typically, have a composition represented by the following average compositional formula (2):

A₂Si_{y}O_{z} (2)

wherein A is at least one trivalent rare earth element selected from the group consisting of Y and lanthanides exclusive of Pm, y is a positive number of at least 1.01 and less than 2, and z is a positive number satisfying 3+2×y.

Preferably, the element A in the average compositional formula (1) or (2) is at least one rare earth element selected from the group consisting of Y, Sm, Gd, Tb, Dy, Ho, Er, Tm, Yb and Lu, Yb alone, or a combination of Yb, and at least one rare earth element selected from the group consisting of Y, Sm, Gd, Tb, Dy, Ho, Er, Tm and Lu.

Preferably, the spraying particles have an angle of repose of up to 42°, a bulk density of at least 1.2 g/cm³, and/or a crushing strength of at least 2 MPa.

In another aspect, the invention provides a method for manufacturing spraying particles of claim 1 comprising the steps of:
(A) mixing rare earth oxide particles and/or rare earth silicate particles, and silicon oxide particles,

granulating the obtained mixture, and

firing the obtained granulated particles;
(B) preparing an aqueous solution of a water-soluble rare earth compound, in which silicon oxide particles are dispersed,

precipitating rare earth compound particles in the solution to form a mixture of the rare earth compound particles and the silicon oxide particles,

granulating the obtained mixture, and

firing the obtained granulated particles; or
(C) granulating rare earth silicate particles having the composition represented by the average compositional formula (1) or (2), and

firing the obtained granulated particles.

Preferably, in the granulating step, each of raw material particles have a BET specific area of at least 1 m²/g.

### Advantageous Effects of Invention

According to the invention, spraying particles having good flowability, a high particle density, typically a bulk density, and a property being hard to break, as spraying particles containing a rare earth silicate, and a manufacturing method thereof can be provided.

### BRIEF DESCRIPTION OF DRAWINGS

FIG. 1 is a scanning electron microscope (SEM) image of the obtained spraying particles in Example 2.

FIG. 2 is a scanning electron microscope (SEM) image of the obtained spraying particles in Example 4.

FIG. 3 is a scanning electron microscope (SEM) image of the obtained spraying particles in Example 5.

FIG. 4 is a scanning electron microscope (SEM) image of the obtained spraying particles in Comparative Example 1.

FIG. 5 is a scanning electron microscope (SEM) image of the obtained spraying particles in Comparative Example 2.

### DESCRIPTION OF PREFERRED EMBODIMENTS

Spraying particles of the invention contains a rare earth silicate. The rare earth silicate has a composition (average composition) represented by the following average compositional formula (1):

(A₂Si_{y}O_{z})_{1-a-b}(CeSiₚO_{q})ₐ(EuSiₘOₙ)_{b} (1)

wherein A is at least one trivalent rare earth element selected from the group consisting of Y and lanthanides exclusive of Pm, y is a positive number of at least 1.01 and less than 2, z is a positive number satisfying 3+2×y, p is a positive number of at least 1 and less than 2, q is a positive number satisfying 2+2×p, m is a positive number of at least 1 and less than 2, n is a positive number satisfying 1+2×m, a and b, respectively, are 0 (zero) or a positive number of up to 0.3, and a+b is up to 0.3. Thus, the rare earth silicate of the invention is a composite oxide or double oxide that consists of a rare earth element, silicon and oxygen.

Herein, the number “y” is preferably up to 1.99. On the other hand, a range of the number “z” depends to the range of the number “y”, the number “z” is at least 5.02, and less than 7, preferably up to 6.98. The number “p” is preferably at least 1.01, and preferably up to 1.99. On the other hand, a range of the number “q” depends to the range of the number “p”, the number “q” is at least 4, preferably at least 4.02, and less than 6, preferably up to 5.98. The number “m” is preferably at least 1.01, and preferably up to 1.99. On the other hand, a range of the number “n” depends to the range of the number “m”, the number “n” is at least 3, preferably at least 3.02, and less than 5, preferably up to 4.98. The numbers “a” and “b”, individually, are preferably 0(zero) or a positive number of up to 0.2, and “a+b” is preferably up to 0.2.

A rare earth element “A” composing the rare earth silicate of the inventive spraying particles, a rare earth element composing particles of a rare earth oxide or a rare earth (mono) silicate as raw material particles, and a rare earth element composing a rare earth compound as a raw material, for spraying particles described below, may be at least one rare earth element selected from the total of 15 elements consisting of yttrium (Y) and lanthanoids exclusive of promethium (Pm), i.e. 14 elements: lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb) and lutetium (Lu). Among them, when handling of rare earth element, property of rare earth silicate, and existential ratio in mineral substances are considered, at least one rare earth element selected from the group consisting of Y, Sm, Gd, Tb, Dy, Ho, Er, Tm, Yb and Lu is preferable. Of these, Yb and Lu are more preferable, and Yb is most preferable. A rare earth element “A” composing the rare earth silicate preferably includes Yb and/or Lu, as an essential constituent. typically, Yb, as an essential constituent. In particular, a rare earth element “A” composing the rare earth silicate is preferably Yb alone, or a combination of Yb, and at least one rare earth element selected from the group consisting of Y, Sm, Gd, Tb, Dy, Ho, Er, Tm and Lu.

Yttrium (Y) and lanthanoids are generally trivalent. Among them, in some cases, cerium (Ce) may be tetravalent, and europium (Eu) may be divalent. The spraying particles of the invention may contain tetravalent Ce and/or divalent Eu as a part of the rare earth element. However, the rare earth element more preferably consists of trivalent rare earth element.

When the spraying particles of the invention contains neither tetravalent Ce nor divalent Eu in the average compositional formula (1), the spraying particles have a composition (average composition) represented by the following average compositional formula (2):

A₂Si_{y}O_{z} (2)

wherein A is at least one trivalent rare earth element selected from the group consisting of Y and lanthanides exclusive of Pm, y is a positive number of at least 1.01 and less than 2, and z is a positive number satisfying 3+2×y. This formula (2) corresponds to the average compositional formula (1) having the numbers “a” and “b” of 0 (zero), respectively.

The spraying particles of the invention is granulated particles. The granulated particles are particles having an enlarged diameter formed by mixing one kind of small particles or two or more kinds of small particles with optionally adding a dispersing agent and a binder and so on, and binding the small particles each other. In a common granulation, the granulated particles are formed from a slurry prepared by mixing the component(s) with a solvent such as water to form a slurry. Granulated particles generally have pores formed due to binding of particles and vaporizing a solvent. Granulated particles can be manufactured by a method such as a spray dry method. Granulated particles are preferably sphere particles in view of flowability. For example, sphere particles having a circularity of at least 0.8 and up to 1.0 that is calculated by the following expression:

Circularity=((area of particle)×4π)/(periphery length of particle)²

in an electron microscope image are preferable.

An average particle size D₅₀ (volume basis) of the spraying particles (granulated particles) is preferably at least 3 μm, more preferably at least 15 μm since flowability is deteriorated when the average particle size D₅₀ is less than 3 μm, however, not limited thereto. An upper limit of the average particle size D₅₀ is normally up to 100 μm. In the invention, a particle distribution including an average particle size D₅₀ may be measured, as volume basis particle size, by laser diffraction/scattering method and so on. For the measurement, a laser diffraction/scattering type particle size distribution measuring apparatus such as MicrotracBEL MT3000, manufactured by MicrotracBEL Coop., may be used.

Spraying particles having good flowability is suitable for uniform feeding to a thermal spraying machine. Particle having low flowability in a thermal spraying machine causes unstable feed of spraying particles to a flame for thermal spraying, and exert a harmful influence to quality of a sprayed film. An angle of repose is an index of flowability, and a small angle of repose is preferable. inAs spraying particles for feeding to a thermal spraying machine when a sprayed film is formed, spraying particles having a high bulk density is preferable for improving spraying efficiency. To increase a bulk density of an inorganic material, generally, it is effective to conduct heat treatment at a higher temperature, and the heat treatment is also useful for improving a bulk density of spraying particles. Further, spraying particles having a high crushing strength is suitable since spraying particles sometimes cause deterioration of flowability or clogging in feed pipe due to breaking of particle while introducing spraying particles into a thermal spraying machine.

However, when a rare earth mono silicate having a stoichiometric composition is heat-treated at higher temperature to improve a bulk density, unlike general inorganic particles, the treatment causes decrease of angle of repose, i.e., deterioration of flowability and decrease of crushing strength. Meanwhile, when a comparatively low temperature is applied, flowability is improved, however, sufficient spraying efficiency cannot be attained due to a low bulk density.

Spraying particles of a rare earth mono silicate R₂SiO₅ which has a stoichiometric composition have a comparatively large angle of repose. Spraying particles having a silicon-rich composition compared with the stoichiometric composition and represented by the average compositional formula (1) or (2) can be attained an angle of repose of up to 42°, preferably of up to 40°. A lower limit of the angle of repose is normally at least 30°, however, not limited thereto. In the present invention, the angle of repose measured by a filling method is adopted. In this method, for example defined in JIS R 9301-2-2, a powder contained in a vessel free falls, and accumulates on a horizontal plane, and angle of accumulated powder is measured.

In the invention, spraying particles having a silicon-rich composition compared with a stoichiometric composition and represented by the average compositional formula (1) or (2) can be attained a bulk density of at least 1.2 g/cm³, preferably at least 1.3 g/cm³. An upper limit of the bulk density is normally up to 65% of the true density, however, not limited thereto. In the present invention, a loose bulk density is be adopted to the bulk density.

In the inventive spraying particles, praying particles having a silicon-rich composition compared with a stoichiometric composition and represented by the average compositional formula (1) or (2) can be attained a crushing strength of at least 2 MPa. An upper limit of the crushing strength is normally up to 120 MPa, however, not limited thereto. The crashing strength can be evaluated by an average of crashing strengths of prescribed number (e.g., 20) of randomly sampled particles. A commercially available apparatus such as Micro Compression Tester MCTM-500, manufactured by Shimadzu Corporation, may be utilized for measuring the crashing strength.

Spraying particles of the invention can be suitably manufactured, for example, by the steps of:
(A) mixing rare earth oxide particles and/or rare earth silicate particles, and silicon oxide particles, granulating, and firing;
(B) preparing an aqueous solution of a water-soluble rare earth compound, in which silicon oxide particles are dispersed, precipitating rare earth compound particles in the solution, granulating a mixture of the rare earth compound particles and the silicon oxide particles, and firing; or
(C) granulating rare earth silicate particles, and firing.

The manufacturing method (A) includes the steps of mixing rare earth oxide particles and/or rare earth silicate particles, and silicon oxide particles, granulating the obtained mixture, and firing the obtained granulated particles. In this mixing step, rare earth oxide particles and/or rare earth silicate particles, and silicon oxide particles may be mixed so that the rare earth element and silicon in the total of the mixture satisfy the composition ratio of the average compositional formula (1) or (2). In this method, firing atmosphere may be air atmosphere, non-oxidative atmosphere such as nitrogen gas atmosphere or inert gas atmosphere.

The manufacturing method (B) includes the steps of preparing an aqueous solution of a water-soluble rare earth compound, in which silicon oxide particles are dispersed, precipitating rare earth compound particles in the solution to form a mixture of the rare earth compound particles and the silicon oxide particles, granulating the obtained mixture, and firing the obtained granulated particles. In this mixing step, water-soluble rare earth compound and silicon oxide particles may be mixed so that the rare earth element and silicon in the total of the mixture satisfy the composition ratio of the average compositional formula (1) or (2). Examples of the rare earth compound particles include oxide particles, and particles of water-insoluble rare earth compound which can form oxide by firing in air such as hydroxides, salts and complexes. The water-soluble rare earth compound may be a compound that can precipitates these water-insoluble rare earth compound particles by forming precipitate accompanying reaction of the water-soluble rare earth compound. As the water-soluble rare earth compound, for example, rare earth nitrate and rare earth chloride are exemplified. In this case, air atmosphere is preferably applied as firing atmosphere.

In both of the manufacturing methods (A) and (B), for example, A₂O₃ particles (herein, A is the same as rare earth element A composing the rare earth silicate), CeO₂ and/or EuO, as the rare earth oxide particles, and, for example, SiO₂ (silicon dioxide) particles, as the silicon oxide particles, are preferably used, respectively. Rare earth oxide particles having a composition ratio of A/O other than A₂O₃ (A/O=2/3), and a silicon oxide having a composition ratio of Si/O other than SiO₂ (Si/O=1/2) may also be used. On the other hand, particles of rare earth mono silicate having a stoichiometric composition such as A₂SiO₅ (wherein A is at least one trivalent rare earth element selected from the group consisting of Y and lanthanides exclusive of Pm), CeSiO₄ and EuSiO₃, as the rare earth silicate particles, are preferably used. A rare earth silicate having a rare earth-rich or silicon-rich composition may also be used.

The manufacturing method (C) includes the steps of granulating rare earth silicate particles having the composition represented by the average compositional formula (1) or (2), and firing the obtained granulated particles.

The particles of rare earth silicate represented by the average compositional formula (1) or (2), as raw material particles in the manufacturing method (C) can be prepared by, for example, (i) mixing rare earth oxide particles and/or rare earth silicate particles, and silicon oxide particles, granulating, and firing, or (ii) preparing an aqueous solution of a water-soluble rare earth compound, in which silicon oxide particles are dispersed, precipitating rare earth compound particles in the solution, and firing a mixture of the rare earth compound particles and the silicon oxide particles. In this case, the same raw materials such as particles and rare earth compound, and the same manufacturing conditions such as firing condition as in the manufacturing methods (A) and (B) can be used. The preparing method for the raw material particles optionally includes granulating step prior to firing step, or pulverizing step subsequent to the firing step.

In the manufacturing methods (A) to (C), each of the methods includes different process steps, however, the resulting particles that have been granulated and fired must be granulated particles satisfying the average composition of (1) or (2). Such granulated particles have superior properties, as spraying particles, in flowability (angle of repose), a bulk density and a strength (crushing strength) compared with a rare earth mono silicate having a stoichiometric composition.

Each of the particles in the granulating step of the manufacturing methods (A) to (C), i.e., raw material particles for providing to the granulation of particles such as rare earth oxide particles, rare earth (mono) silicate particles, silicon oxide particles, and rare earth compound particles have a BET specific area of preferably at least 1 m²/g, more preferably at least 10 m²/g. An upper limit of the BET specific area is normally up to 320 m²/g in each of the raw material particles. An average particle size D₅₀ of each of the raw material particles are preferably up to 5 μm, more preferably up to 1 μm. The particle size is too large, the shape of the resulting spraying particles after firing may be easy to deviate from spherical shape, and flowability of the obtained spraying particles may deteriorates. A lower limit of the average particle size D₅₀ is normally at least 0.05 μm in each of the raw material particles.

To granulate the raw material particles, the particles provided to the granulation is generally mixed with water, an organic solvent such as ethanol, or a mixed solvent of water and an organic solvent to form a slurry. The mixing may be conducted by a mixer, however, a pulverizing and stirring mixer such as a ball mill is preferably used for mixing homogeneously. A small amount of a dispersing agent or a binder may be also mixed to disperse the raw material particles and to improve particle form of the granulated particles. The dispersion agent and binder, respectively, are preferably an organic material (organic compound) that does not remain in the spraying particles in the firing step. As the dispersion agent and binder, for example, a water-soluble organic polymer such as polycarboxylic acid, methylcellulose, carboxymethylcellulose and its derivative, and polyvinyl alcohol, polyester, polyacrylic acid and derivative thereof are exemplified.

In the manufacturing methods (A) to (C), the granulating is preferably conducted from a slurry by using a granulation apparatus such as a spray dryer which contributes high productivity. In the manufacturing methods (A) to (C), firing temperature of the granulated particle for manufacturing the spraying particles is preferably at least 800° C., more preferably at least 1,000° C. A temperature less than a melting point of the material composing the granulated particles is generally suitable for an upper limit of the firing temperature. However, the firing temperature is set too high in the firing of the granulated particle for manufacturing the spraying particles, adhesion of particles is possibly developed, inviting deterioration of flowability of spraying particles. Thus, the upper limit of the firing temperature is preferably up to 1,650° C., more preferably up to 1,600° C. Atmosphere containing oxygen gas, atmosphere containing nitrogen gas, and atmosphere containing an inert gas such as helium gas and argon gas are exemplified as a firing atmosphere. Among them, atmosphere containing oxygen gas such as air atmosphere is preferable since carbon, nitrogen and hydrogen can be eliminated (fired) by oxidation. A firing time can be set, for example, in a range of 30 minutes to 4 hours.

A sprayed film can be formed by a thermal spraying method by using the spraying particles of the invention. The spraying particles is suitable for atmospheric plasma spraying in which a plasma is formed under air atmosphere. The plasma spraying may be suspension plasma spraying. A sprayed coating can be also formed by a commonly known method by using the spraying particles of the invention. A spraying member including a sprayed coating disposed on a substrate can be manufactured by using the spraying particles of the invention. Particularly, the spraying particles of the invention are effective for manufacturing such as a ceramic matrix composites (CMC) in which an environmental barrier coating (EBC) is formed.

### EXAMPLES

Examples of the invention are given below by way of illustration and not by way of limitation.

An average particle size D₅₀ (volume basis) was measured by MicrotracBEL MT3000, manufactured by MicrotracBEL Coop. A crashing strength of the spraying particles was measured by Micro Compression Tester MCTM-500, manufactured by Shimadzu Corporation, and evaluated as an average of 20 particles. Compositions were measured by ICP (Inductively Coupled Plasma) with respect to rare earth elements and silicon (Si). and the balance was presumed as oxygen.

### Example 1

4,360 g of ytterbium oxide (Yb₂O₃) particles having a BET specific area of 13 m²/g, 635 g of silicon dioxide (SiO₂) particles having a BET specific area of 203 m²/g, and 10 L of pure water with adding 45 g of polycarboxylic acid, as a dispersing agent, and 25 g of polyvinyl alcohol, as a binder, were mixed by a ball mill for 4 hours to form a slurry. Then, about 5,000 g of unfired granulated particles having an average particle size D₅₀ of 38 μm were obtained by granulating from the obtained slurry by using a spray dryer. Next, the unfired granulated particles were fired under air atmosphere at 1,450° C. for 2 hours, and spherical spraying particles having an average particle size D₅₀ of 36 μm were obtained.

The determined composition of the obtained spraying particles was the average composition of Yb₂Si_{1.04}O_{5.08}. The spraying particles had an angle of repose of 35.7°, a bulk density of 1.52 g/cm³, and a crashing strength of 2.15 MPa, and were suitable particles for a thermal spraying. The results are shown in Table 1.

### Example 2

1,200 g of silicon dioxide (SiO₂) particles having a BET specific area of 203 m²/g were dispersed in 100 L of pure water to form a slurry. An aqueous solution of ytterbium nitrate (Yb(NO₃)₃) of an amount equivalent to 40 moles of ytterbium nitrate, and 35 kg of urea were mixed with the obtained slurry, then heated at 98° C. for 4 hours, obtaining a precipitate. The obtained precipitate was collected by filtrating, then fired under air atmosphere at 700° C. for 4 hours, followed by breaking the fired precipitate by a crushing machine, and further firing under air atmosphere at 1,080° C. for 2 hours. 9,000 g of raw material particles of ytterbium silicate having a BET specific surface area of 15 m²/g and an average particle size D₅₀ of 1.6 μm were obtained. The determined composition of the obtained raw material particles was the average composition of Yb₂Si_{1.00}O_{5.00} corresponding to a stoichiometric composition. The raw material particles were identified by XRD as ytterbium mono silicate (Yb₂SiO₅).

Next, 5,000 g of the obtained ytterbium silicate raw material particles having a stoichiometric composition and a BET specific area of 15 m²/g, 30 g of silicon dioxide (SiO₂) particles having a BET specific area of 203 m²/g, and 10 L of pure water with adding 45 g of polycarboxylic acid, as a dispersing agent, and 25 g of polyvinyl alcohol, as a binder, were mixed by a ball mill for 4 hours to form a slurry. Then, about 5,100 g of unfired granulated particles having an average particle size D₅₀ of 45 μm were obtained by granulating from the obtained slurry by using a spray dryer. Next, the unfired granulated particles were fired under air atmosphere at 1,450° C. for 2 hours, and spherical spraying particles having an average particle size D₅₀ of 40 μm. In were obtained.

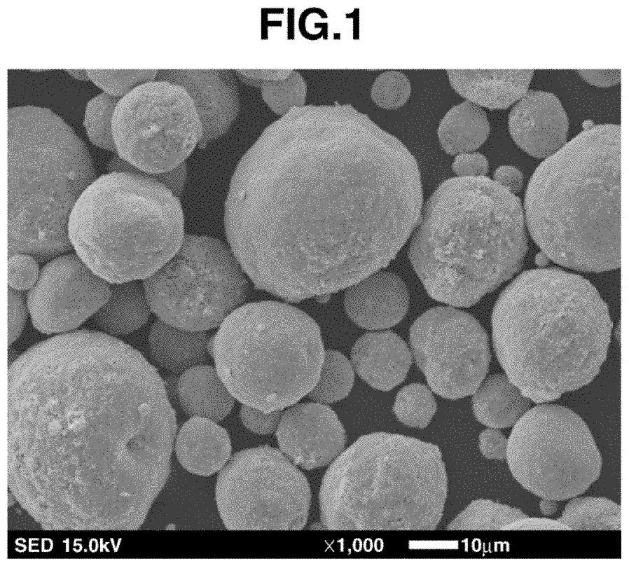

The determined composition of the obtained spraying particles was the average composition of Yb₂Si_{1.02}O_{5.05}. An electron microscope (SEM) image of the obtained spraying particles is shown in FIG. 1. The spraying particles had an angle of repose of 36.6°, a bulk density of 1.31 g/cm³, and a crashing strength of 2.17 MPa, and were suitable particles for a thermal spraying. The results are shown in Table 1.

### Example 3

8,750 g of ytterbium oxide (Yb₂O₃) particles having a BET specific area of 13 m²/g, and 1,250 g of silicon dioxide (SiO₂) particles having a BET specific area of 180 m²/g, were mixed and fired under air atmosphere at 965° C. for 2 hours, followed by breaking. 10,000 g of raw material particles of ytterbium silicate having a BET specific surface area of 15 m²/g and an average particle size D₅₀ of 2.3 μm were obtained. The determined composition of the obtained raw material particles was the average composition of Yb₂Si_{0.94}O_{4.87}.

Next, 5,000 g of the obtained raw material particles of ytterbium silicate, 64 g of silicon dioxide (SiO₂) particles having a BET specific area of 203 m²/g, and 10 L of pure water with adding 45 g of polycarboxylic acid, as a dispersing agent, and 25 g of polyvinyl alcohol, as a binder, were mixed by a ball mill for 4 hours to form a slurry. Then, about 5,000 g of unfired granulated particles having an average particle size D₅₀ of 40 μm were obtained by granulating from the obtained slurry by using a spray dryer. Next, the unfired granulated particles were fired under air atmosphere at 1,450° C. for 2 hours, and spherical spraying particles having an average particle size D₅₀ of 40 μm were obtained.

The determined composition of the obtained spraying particles was the average composition of Yb₂Si_{1.03}O_{5.03}. The spraying particles had an angle of repose of 35.2°, a bulk density of 1.40 g/cm³, and a crashing strength of 5.21 MPa, and were suitable particles for a thermal spraying. The results are shown in Table 1.

### Example 4

2,000 g of silicon dioxide (SiO₂) particles having a BET specific area of 203 m²/g were dispersed in 500 L of pure water to form a slurry. An aqueous solution of ytterbium nitrate (Yb(NO₃)₃) of an amount equivalent to 40 moles of ytterbium nitrate, and 40 kg of urea were mixed with the obtained slurry, then heated at 98° C. for 4 hours, obtaining a precipitate. The obtained precipitate was collected by filtrating, then fired under air atmosphere at 700° C. for 4 hours, followed by breaking the fired precipitate by a crushing machine, and further firing under air atmosphere at 1,030° C. for 2 hours. 10,760 g of raw material particles of ytterbium silicate having a BET specific surface area of 13 m²/g and an average particle size D₅₀ of 1.6 μm were obtained. The determined composition of the obtained raw material particles was the average composition of Yb₂Si_{1.50}O_{6.00}.

Next, 5,000 g of the obtained raw material particles of ytterbium silicate, and 10 L of pure water with adding 45 g of polycarboxylic acid, as a dispersing agent, and 25 g of polyvinyl alcohol, as a binder, were mixed by a ball mill for 4 hours to form a slurry. Then, about 5,000 g of unfired granulated particles having an average particle size D₅₀ of 45 μm were obtained by granulating from the obtained slurry by using a spray dryer. Next, the unfired granulated particles were fired under air atmosphere at 1,400° C. for 2 hours, and spherical spraying particles having an average particle size D₅₀ of 43 μm were obtained.

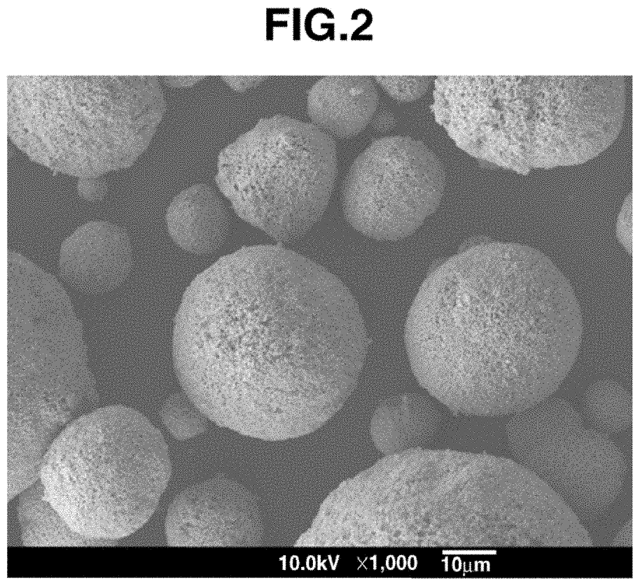

The determined composition of the obtained spraying particles was the average composition of Yb₂Si_{1.50}O_{6.00}. An electron microscope (SEM) image of the obtained spraying particles is shown in FIG. 2. The spraying particles had an angle of repose of 35.0°, a bulk density of 1.51 g/cm³, and a crashing strength of 21.5 MPa, and were suitable particles for a thermal spraying. The results are shown in Table 1.

### Example 5

3,850 g of ytterbium oxide (Yb₂O₃) particles having a BET specific area of 13 m²/g, 1,150 g of silicon dioxide (SiO₂) particles having a BET specific area of 203 m²/g, and 10 L of pure water with adding 45 g of polycarboxylic acid, as a dispersing agent, and 25 g of polyvinyl alcohol, as a binder, were mixed by a ball mill for 4 hours to form a slurry. Then, about 5,000 g of unfired granulated particles having an average particle size D₅₀ of 45 μm were obtained by granulating from the obtained slurry by using a spray dryer. Next, the unfired granulated particles were fired under air atmosphere at 1,400° C. for 2 hours, and spherical spraying particles having an average particle size D₅₀ of 42 μm were obtained.

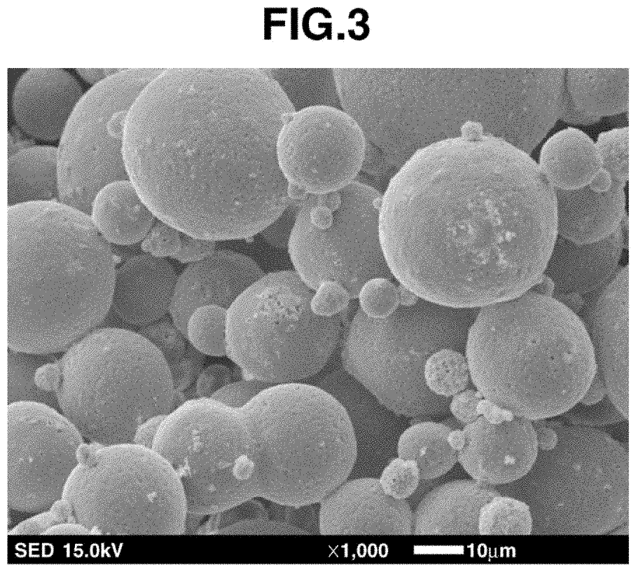

The determined composition of the obtained spraying particles was the average composition of Yb₂Si_{1.96}O_{6.92}. An electron microscope (SEM) image of the obtained spraying particles is shown in FIG. 3. The spraying particles had an angle of repose of 34.0°, a bulk density of 1.95 g/cm³, and a crashing strength of 37.2 MPa, and were suitable particles for a thermal spraying. The results are shown in Table 1.

### Comparative Example 1

5,000 g of ytterbium silicate raw material particles having a BET specific area of 15 m²/g and an average particle size D₅₀ of 1.6 μm, which were obtained by the same method in Example 2, and 10 L of pure water with adding 45 g of polycarboxylic acid, as a dispersing agent, and 25 g of polyvinyl alcohol, as a binder, were mixed by a ball mill for 4 hours to form a slurry. Then, about 5,100 g of unfired granulated particles having an average particle size D₅₀ of 45 μm were obtained by granulating from the obtained slurry by using a spray dryer. Next, the unfired granulated particles were fired under air atmosphere at 6 sorts of temperatures from 1, 450 to 1,680° C. as shown in Table 1 for 2 hours, respectively, and 6 sorts of spherical spraying particles having an average particle size D₅₀ of about 40 μm in each of the particles were obtained.

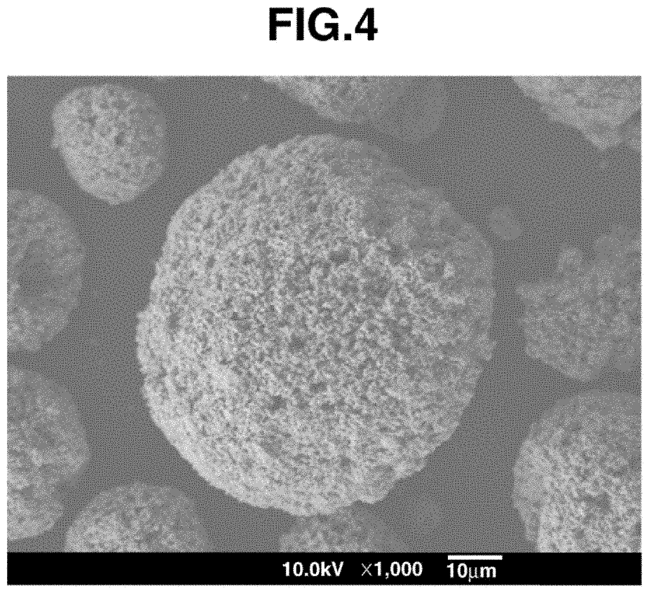

All of the determined compositions of the 6 sorts of the obtained spraying particles were, respectively, the average composition of Yb₂Si_{1.00}O_{5.00} corresponding to a stoichiometric composition. Among them, an electron microscope (SEM) image of the obtained spraying particles which were fired at 1,450° C. is shown in FIG. 4. Angles of repose, bulk densities and crashing strengths of the 6 sorts of the spraying particles are shown in Table 1. Among the spraying particles, the spraying particles fired at a high temperature had the high bulk density, however, the angle of repose was large, resulting low flowability. Further, all of the spraying particles had a crushing strength of up to 1 MPa, and were easily broken and unsuitable for a thermal spraying.

### Comparative Example 2

4,500 g of ytterbium oxide (Yb₂O₃) particles having a BET specific area of 15 m²/g, and 645 g of silicon dioxide (SiO₂) particles having a BET specific area of 203 m²/g, were mixed and fired under air atmosphere at 1,080° C. for 4 hours, followed by breaking. 5,100 g of raw material particles of ytterbium silicate having a BET specific surface area of 15 m²/g and an average particle size D₅₀ of 1.5 μm were obtained. The determined composition of the obtained raw material particles was the average composition of Yb₂Si_{0.94}O_{4.87}.

Next, 5,000 g of the obtained raw material particles of ytterbium silicate, and 10 L of pure water with adding 45 g of polycarboxylic acid, as a dispersing agent, and 25 g of polyviny lalcohol, as a binder, were mixed by a ball mill for 4 hours to form a slurry. Then, about 5,000 g of unfired granulated particles having an average particle size D₅₀ of 42 μm were obtained by granulating from the obtained slurry by using a spray dryer. Next, the unfired granulated particles were fired under air atmosphere at 1,450° C. for 2 hours, and spherical spraying particles having an average particle size D₅₀ of 40 μm were obtained.

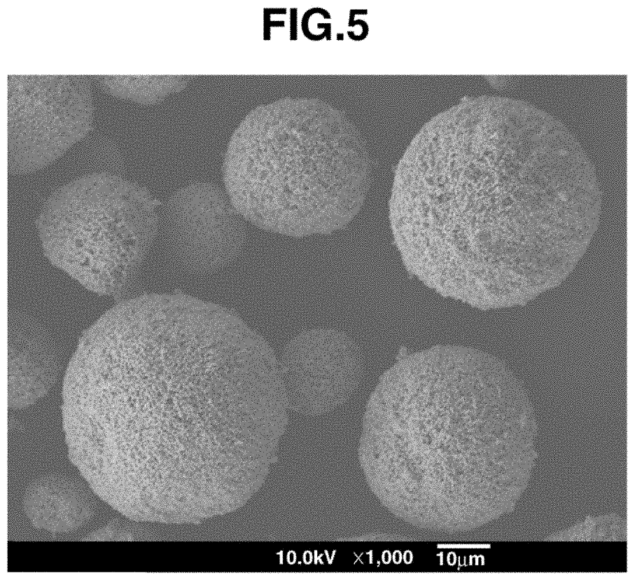

The determined composition of the obtained spraying particles was the average composition of Yb₂Si_{0.94}O_{4.87} that is the ytterbium-rich composition compared with Yb₂Si_{1.00}O_{5.00} corresponding to a stoichiometric composition. An electron microscope (SEM) image of the obtained spraying particles is shown in FIG. 5. The spraying particles had an angle of repose of 41.0°, a bulk density of 1.09 g/cm³, and a crashing strength of 0.46 MPa. The results are shown in Table 1. The spraying particles had flowability which may be accepted for use in a thermal spraying, however had a low bulk density. Further, the spraying particles had a crushing strength of up to 1 MPa, and were easily broken and unsuitable for a thermal spraying.

TABLE 1

| | | Firing | | | |
|---|---|---|---|---|---|
| | | Temper- | Angle of | Bulk | Crushing |
| | Average | ature | Repose | Density | Strength |
| | Composition | [° C.] | [°] | [g/cm³] | [MPa] |
| Example 1 | Yb₂Si_{1.04}O_{5.08} | 1,450 | 35.7 | 1.52 | 2.15 |
| Example 2 | Yb₂Si_{1.02}O_{5.05} | 1,450 | 36.6 | 1.31 | 2.17 |
| Example 3 | Yb₂Si_{1.03}O_{5.06} | 1,450 | 35.2 | 1.40 | 5.21 |
| Example 4 | Yb₂Si_{1.50}O_{6.00} | 1,400 | 35.0 | 1.51 | 21.5 |
| Example 5 | Yb₂Si_{1.96}O_{6.92} | 1,400 | 34.0 | 1.95 | 37.2 |
| Compar- | Yb₂Si_{1.00}O_{5.00} | 1,450 | 43.7 | 0.94 | 0.97 |
| ative | | 1,500 | 45.1 | 0.99 | 0.65 |
| Example 1 | | 1,550 | 47.0 | 1.05 | <0.30 |
| | | 1,600 | 47.5 | 1.14 | <0.30 |
| | | 1,650 | 50.1 | 1.29 | <0.30 |
| | | 1,680 | 53.7 | 1.36 | <0.30 |
| Compar- | Yb₂Si_{0.94}O_{4.72} | 1,450 | 41.0 | 1.09 | 0.46 |
| ative | | | | | |
| Example 2 | | | | | |

Japanese Patent Application No. 2018-234278 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. Spraying particles comprising a rare earth silicate wherein the spraying particles are granulated particles and have a composition represented by the following average compositional formula (1):
(A₂Si_{y}O_{z})_{1-a-b}(CeSiₚO_{q})ₐ(EuSiₘOₙ)_{b} (1)
wherein A is at least one trivalent rare earth element selected from the group consisting of Y and lanthanides exclusive of Pm, y is a positive number of at least 1.01 and less than 2, z is a positive number satisfying 3+2×y, p is a positive number of at least 1 and less than 2, q is a positive number satisfying 2+2×p, m is a positive number of at least 1 and less than 2, n is a positive number satisfying 1+2×m, a and b, respectively, are 0 or a positive number of up to 0.3, and a+b is up to 0.3.

2. The spraying particles of claim 1 having a composition represented by the following average compositional formula (2):
A₂Si_{y}O_{z} (2)
wherein A is at least one trivalent rare earth element selected from the group consisting of Y and lanthanides exclusive of Pm, y is a positive number of at least 1.01 and less than 2, and z is a positive number satisfying 3+2×y.

3. The spraying particles of claim 1 wherein the element A in the average compositional formula (1) is at least one rare earth element selected from the group consisting of Y, Sm, Gd, Tb, Dy, Ho, Er, Tm, Yb and Lu.

4. The spraying particles of claim 3 wherein the element A in the average compositional formula (1) is Yb alone, or a combination of Yb, and at least one rare earth element selected from the group consisting of Y, Sm, Gd, Tb, Dy, Ho, Er, Tm and Lu.

5. The spraying particles of claim 1 having an angle of repose of up to 42°.

6. The spraying particles of claim 1 having a bulk density of at least 1.2 g/cm³.

7. The spraying particles of claim 1 having a crushing strength of at least 2 MPa.

8. A method for manufacturing spraying particles of claim 1 comprising the steps of:
mixing rare earth oxide particles and/or rare earth silicate particles, and silicon oxide particles,
granulating the obtained mixture, and
firing the obtained granulated particles.

9. A method for manufacturing spraying particles of claim 1 comprising the steps of:
to preparing an aqueous solution of a water-soluble rare earth compound, in which silicon oxide particles are dispersed,
precipitating rare earth compound particles in the solution to form a mixture of the rare earth compound particles and the silicon oxide particles,
granulating the obtained mixture, and
firing the obtained granulated particles.

10. A method for manufacturing spraying particles of claim 1 comprising the steps of:
granulating rare earth silicate particles having the composition represented by the average compositional formula (1), and
firing the obtained granulated particles.

11. The method of claim 8 wherein in the granulating step, each of raw material particles have a BET specific area of at least 1 m²/g.

12. The spraying particles of claim 2 wherein the element A in the average compositional formula (2) is at least one rare earth element selected from the group consisting of Y, Sm, Gd, Tb, Dy, Ho, Er, Tm, Yb and Lu.

13. The spraying particles of claim 12 wherein the element A in the average compositional formula (2) is Yb alone, or a combination of Yb, and at least one rare earth element selected from the group consisting of Y, Sm, Gd, Tb, Dy, Ho, Er, Tm and Lu.

14. The spraying particles of claim 2 having an angle of repose of up to 42°.

15. The spraying particles of claim 2 having a bulk density of at least 1.2 g/cm³.

16. The spraying particles of claim 2 having a crushing strength of at least 2 MPa.

17. A method for manufacturing spraying particles of claim 2 comprising the steps of:
mixing rare earth oxide particles and/or rare earth silicate particles, and silicon oxide particles,
granulating the obtained mixture, and
firing the obtained granulated particles.

18. A method for manufacturing spraying particles of claim 2 comprising the steps of:
preparing an aqueous solution of a water-soluble rare earth compound, in which silicon oxide particles are dispersed,
precipitating rare earth compound particles in the solution to form a mixture of the rare earth compound particles and the silicon oxide particles,
granulating the obtained mixture, and
firing the obtained granulated particles.

19. A method for manufacturing spraying particles of claim 2 comprising the steps of:
granulating rare earth silicate particles having the composition represented by the average compositional formula (2), and
firing the obtained granulated particles.

20. The method of claim 19 wherein in the granulating step, each of raw material particles have a BET specific area of at least 1 m²/g.
